(19) United States
(12) Patent Application Publication
(10) Pub. No.: US 2013/0324426 A1
(43) Pub. Date: Dec. 5, 2013

(54) Method to improve protein production

(71) Applicant: Elena E. Brevnova, Belmont, MA (US)

(72) Inventor: Elena E. Brevnova, Belmont, MA (US)

(21) Appl. No.: 13/905,350

(22) Filed: May 30, 2013

Related U.S. Application Data
(60) Provisional application No. 61/689,137, filed on May 31, 2012.

(51) Int. Cl. C40B 30/02

(52) U.S. Cl. CPC C40B 30/02
USPC 506/8; 506/24

(57) ABSTRACT

Method to create in silico protein mutants with improved expression level in an expression host compared to an original protein. The mutants retain unaltered or minimally altered function and specific activity that is at the same or higher level compared to the original protein. The method also allows predicting one or more optimal expression host(s) for the given protein and mutants for maximum production level in the predicted optimal host(s). The method is based on optimizing protein sequence parameters that are important for protein expression, such as amino acid composition, guanine-cytosine (GC) content, RNA secondary structure, amount of charged amino acids on the surface, and length of the protein, among other parameters.

### BACKGROUND

Low-cost production of proteins in heterologous and homologous hosts is a fundamental capability on which biotechnology depends. Enzyme-catalyzed industrial processes are increasingly common in applications ranging from food processing to manufacture of small molecule pharmaceuticals. Even manufacturers of high-value protein therapeutics such as insulin and monoclonal antibodies are sensitive to the costs of making protein, particularly as patents expire for these drugs. It is an object of this invention to improve production levels of proteins in expression hosts.

Maximizing heterologous protein expression is a multidimensional optimization problem. The major factors that effect protein expression are 1) protein encoding gene, 2) expression vector, 3) host strain and 4) bioprocess. Each of these factors is defined by a distinct set of variables that can be optimized for better expression. For example, gene sequence can be optimized for better expression by optimizing codon usage, mRNA structure, GC content, regulatory motifs, and repeats, among other variables. Vector-related variables include: replication origin, promoters, RBS, regulatory elements, and terminators, inter alia. Host strain can be improved by optimizing selection marker, protease deficiency, redox environment, recombinases, polymerases, and folding chaperones, among others. Major bioprocess parameters that can be optimized include, without limitation: temperature, carbon source, nutrients, aeration and pH.

Most of protein expression optimization efforts to date have been concentrated on optimizing expression vectors, host strains and bioprocess parameters. The more recent efforts on gene engineering became enabled by development of high throughput screening, synthetic biology and computational biology tools. FIG. 1 illustrates the major modern approaches used to optimize a protein's function and/or expression by gene screening or engineering. A gene optimization step 1 has typically been accomplished by either a step 10 of changing sequence of a particular gene of interest or a step 20 of screening multiple proteins for desired properties. Within step 10, gene sequence changes can either change amino acid (a.a.) sequence of the protein or keep the sequence unaltered (codon optimization). After step 10 is completed, often the diverse set of genes is generated that can be screened for either improved, modified or novel function in a step 30, or for optimal expression in the desired expression host in the step 40. The step 20 of screening different proteins is usually aimed toward either screening to find the protein with an optimal function in the step 50 or toward screening to find the protein with an optimal expression in the desired expression host in the step 60. Both steps 30 and 40 can be accomplished by the step 80 of random or semi-random protein mutagenesis approach followed by in vitro or in vivo high throughput screening (HTS) for desired properties (See Wilson et al., 1994; Wong et al., 2004; Maté et al., 2010, all of which references are incorporated herein in their entirety). This approach is called sometimes “directed evolution”. In the step 80, nucleotide base pair (b.p.) changes introduced by the mutagenesis can either change amino acid sequence of the protein or leave it unaltered. Step 70 of computational protein mutant library design is currently used to accomplish step 30 of creating a protein mutant with improved or modified or novel function (See Siegel et al., 2010; Lutz et al., 2010, all of which references are incorporated herein in their entirety). In the step 70, the changes in the gene sequence do change the amino acid sequence of the protein. In the step 70, the key amino acids that are thought to be implicated in protein function are mutated in silico. The large set of generated mutants can be then analyzed computationally resulting in much smaller set of mutants that have higher calculated probability to have desired properties. The smaller set of the mutants can then be screened in vivo or in vitro for the presence of the desired properties.

Still referring to FIG. 1, step 90 of computational DNA optimization (codon optimization) is the most commonly used approach to modify gene sequence for optimal expression (See Welch et al., 2009; Gustafsson et al., 2012, incorporated herein by reference in their entirety). In the step 90, DNA sequence of the gene is modified, but the amino acid sequence of the protein is kept unaltered. Up until recently, screening of different proteins for optimal function (step 50) or expression (step 60) was accomplished by direct in vivo or in vitro experimental screening. A recent study of Van den Berg et al. (2010; incorporated herein in its entirety) demonstrated that it is possible to computationally predict the probability of the protein to be successfully expressed based on amino acid sequence. In that study, an expression classifier was created—the algorithm that allowed predicting protein expression based on amino acid sequence parameters known to be important for expression from experimental data set. Therefore, the step 60 of screening different proteins for the optimal expression has been accomplished by the step 100 of in silico screening of a large protein set for the optimal expression in the desired host, which screening yields a much smaller set of the proteins having an increased probability of successful expression. This resulting smaller set of proteins is then screened in vivo to find the best expression.

It is desirable to continue to develop improved methods and systems for increasing protein expression. To our knowledge the approach described in the step 100 has not been applied for screening of large sets of in silico generated protein mutants. And to our knowledge, the approach described in the step 70 has never been used for protein production optimization.

### SUMMARY

The invention provides generally for methods for improving protein production. At least one embodiment provides for a step of generating mutants in silico with DNA and protein sequence optimized for expression.

At least one preferred embodiment of the invention provides for optimizing protein sequence for optimal expression and minimal impact on function and activity by using a selection process that is based on sequence parameters from the group including one or more of following parameters, without limitation: amino acid composition, GC content, RNA secondary structure, amount of charged amino acids on the surface, length of the protein, nucleotide composition, hydrophobic peaks, hydrophilic peaks, and isoelectric points.

An embodiment of the invention provides further for a first set of amino acids (a.a.) in a protein to be selected for substitution by a second set of amino acids, wherein the amino acids of each set are chosen based on solved or predicted secondary structure, alignment with homologous proteins and optionally other evidence, such that substitution of the second set for the first set imposes minimal or least effect on protein function and activity. The amino acids selected for substitution can be specified by reference to their sequence number as “selected variable positions.” Selecting a first set of amino acids to be substituted can be accomplished by determining a group of conservative amino acids with respect to preserving a desired function and/or activity, such that the non-conservative amino acids comprise the selected variable positions.

In one embodiment, the set of selected variable positions can be passed to an expression level optimization module, implemented in computer software, that utilizes a classifier routine to evaluate multiple candidate protein sequences. The classifier routine provides a score for each candidate protein sequence based on a set of classification parameters. The scoring procedure of the classifier routine is established by the classifier having previously evaluated a set of training data, wherein the training data are formed from a set of proteins of the same general class of the subject protein, wherein the same classifications parameters have been measured in the training proteins and wherein additionally a expression performance has been tested experimentally and/or determined for each of the training proteins in the training set.

The multiple candidate protein sequences that are being classified will have been mutated in silico by another subroutine of the optimization module or a separate software module. This mutation step comprises varying the amino acid of each of the selected variable positions of the candidate proteins that will be submitted to the classifier.

A preferred embodiment can provide further for use of an additional classifier analysis in which the DNA sequence of the protein-encoding gene for the selected, optimized mutant is itself codon-optimized for better expression by optimizing such parameters that include, but are not limited to, sequence repeats, splice sites, RNA secondary structures, poly A sites, killer motifs, codon usage, and GC content.

Embodiments of the invention provide further for the protein expression being homologous or heterologous, and/or the protein expression being cell-associated or extracellular (secretion).

One or more embodiments provide for the expression host being any one of bacteria, yeast, filamentous fungi, mammalian cells, insect cells, plant, algae, protest and any organism that can be used for protein production.

Further embodiments of the invention provide for the method to be implemented in a computing environment, including steps carried out by software modules. One or more embodiments of the invention provide certain program functions to carry out various steps of the protein expression optimization. Further embodiments provide for a protein optimization system, or platform, comprising computer hardware, software and additional equipment.

The invention provides for the business service that includes software that analyzes customer gene sequence and generates set of gene mutants with sequences optimized for expression in customer host. The software will also generate list of optimal hosts for the customer protein and generate sets of gene mutants with sequences optimized for expression in recommended hosts. The software can be delivered to the customer as online service or for purchase on a disk.

### LIST OF DRAWINGS

FIG. 1 illustrates modern approaches currently used for gene optimization.

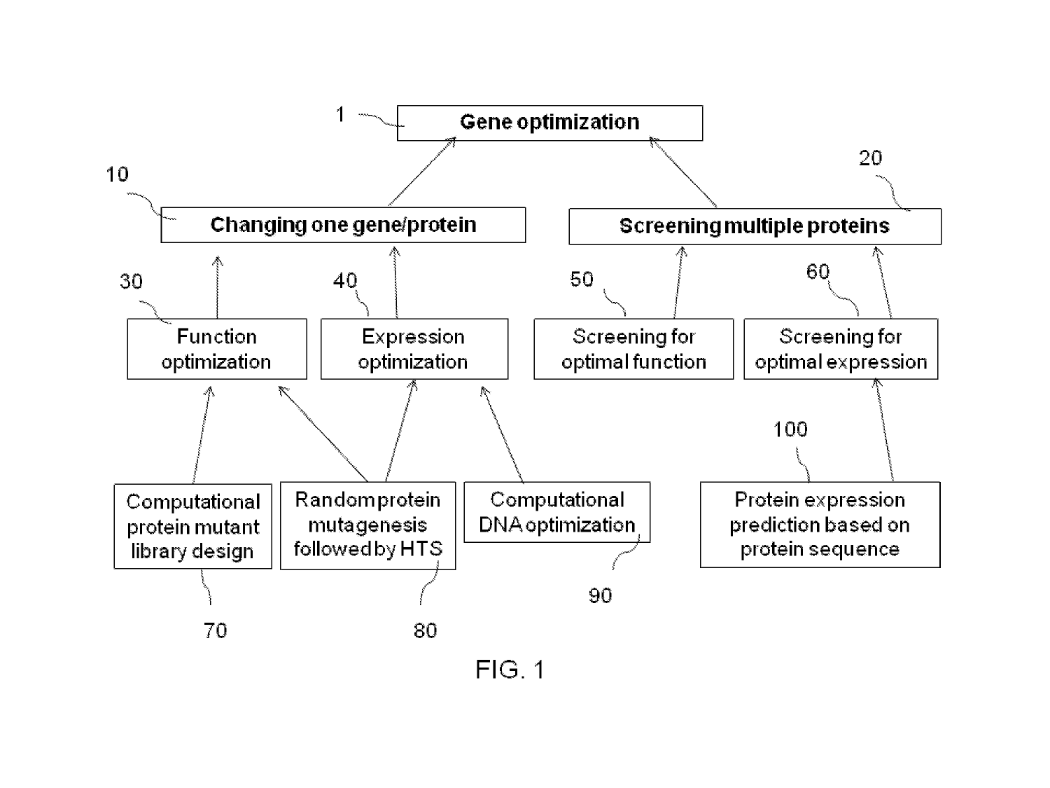

FIG. 2 illustrates a novel method according to an embodiment of the invention to improve protein expression that combines computational DNA optimization with computational protein sequence optimization.

FIG. 3 illustrates a work flow according to an embodiment of the invention in the form of a diagram for protein production and host optimization.

FIG. 4 illustrates a computing system according to an embodiment of the invention capable of managing aspects of the work flow for protein production and host optimization.

FIG. 5 illustrates software modules and connectivity according to an embodiment of the invention capable of managing aspects of the work flow for protein production and host optimization.

FIG. 6 illustrates an Internet-based business method according to an embodiment of the invention.

### DETAILED DESCRIPTION

This is a non-provisional, utility patent application that stems from and hereby incorporates by reference in its entirety U.S. Provisional Patent Application No. 61/689,137, filing date May 31, 2012, confirmation no. 2918, from which provisional application the priority date is claimed.

This specification further explicitly references U.S. patent application Ser. No. 12/009,793, filed Jan. 22, 2008, having priority to U.S. Provisional Application No. 60/881,638, filed Jan. 22, 2007; U.S. patent application Ser. No. 12/290,731, filed Nov. 3, 2008, having priority to U.S. Provisional Application No. 60/985,160, filed Nov. 2, 2007; U.S. Divisional patent application Ser. No. 13/339,370, filed Dec. 28, 2011; and U.S. C-I-P patent application Ser. No. 13/351,210, filed Jan. 16, 2012, all of which foregoing referenced applications are inventions or co-inventions of this same inventor and/or are applications assigned to a common person or inventorship entity as this instant application, and all of which foregoing referenced patent applications are incorporated herein by reference in their entirety.

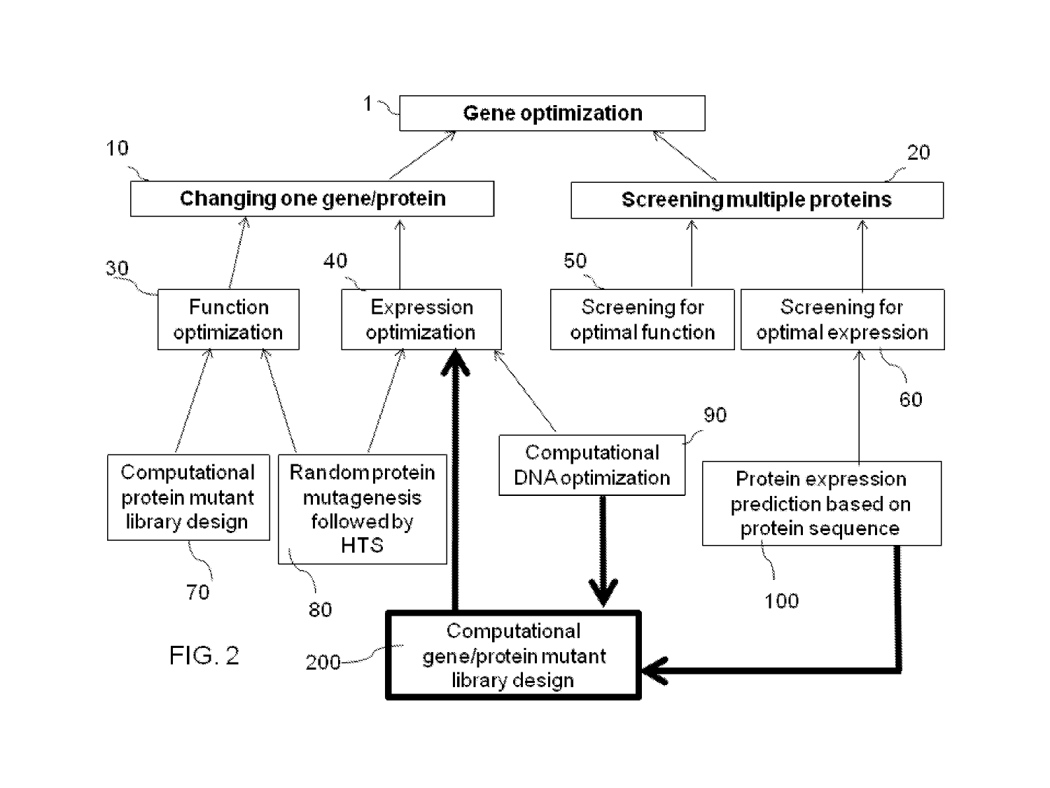

At least one preferred embodiment of the invention provides for one or more methods for improving protein production by generating mutants in silico with DNA and protein sequence optimized for expression. FIG. 2 illustrates the place of this novel method in the context of other major approaches currently used to optimize a protein's function and/or expression by gene screening or engineering. A gene optimization step 1 can be accomplished by either step 10 of changing sequence of a particular gene of interest or step 20 of screening multiple proteins for desired properties. An example of a particular protein of interest in the step 10 can be a monoclonal antibody, such as anti-HER2. An example of the expression host in the step 10 can be mammalian CHO cells. During step 10, gene sequence changes can either change amino acid (a.a.) sequence of the protein or keep it unaltered (codon optimization). In order to fulfill step 10, a diverse set of genes is generated that can be screened for either improved or modified or novel function, shown as step 30, or for optimal expression in the desired expression host, shown as step 40. The step 20 of screening different proteins can be aimed to either find the protein with an optimal function, as shown in the step 50, or to find the protein with an optimal expression in the desired expression host in the step 60. An example of different proteins in the step 20 can be a set of hydrolases from different cellulolytic filamentous fungi such as Trichoderma reesei. These hydrolases can be cellobiohydrolases, endoglucanases, beta-glucosidases, glucoamylases, alpha-amylases, alpha glucoasidases and others. The example of the expression host for hydrolases can be yeast Saccharomyces cerevisiae.

Still referring to FIG. 2, both steps 30 and 40 can be accomplished by the step 80 of random or semi-random protein mutagenesis approach followed by in vitro or in vivo high throughput screening (HTS) for desired properties (See Wilson et al., 1994; Wong et al., 2004; Maté et al., 2010, all of which references are incorporated herein in their entirety). This approach is called sometimes “directed evolution”. In the step nucleotide base pair (b.p.) changes introduced by the mutagenesis can either change amino acid sequence of the protein or leave it unaltered. Step 70 of computational protein mutant library design is currently used to accomplish step 30 of creating a protein mutant with improved or modified or novel function (See Siegel et al., 2010; Lutz et al., 2010, all of which references are incorporated herein in their entirety). In the step 70, the changes in the gene sequence do change the amino acid sequence of the protein. In the step 70, the key amino acids that are thought to be implicated in protein function are mutated in silico. The large set of generated mutants can be then analyzed computationally, resulting in a much smaller set of mutants that have higher calculated probability to have desired properties. The smaller set of the mutants can then be screened in vivo or in vitro for the presence of the desired properties. To our knowledge, the approach described in the step 70 currently has not been used for protein production optimization.

Step 90 of computational DNA optimization (codon optimization) is the most commonly used approach to modify gene sequence for the optimal expression (See Welch et al., 2009; Gustafsson et al., 2012, incorporated herein by reference in their entirety). In the step 90, DNA sequence of the gene is modified, but an amino acid sequence of the protein is kept unaltered. Up until recently, screening of different proteins for optimal function (step 50) or expression (step 60) was accomplished by direct in vivo or in vitro experimental screening. Recent study of Van den Berg et al. (2010; incorporated herein in its entirety) demonstrated that it is possible to computationally predict the probability of the protein to be successfully expressed based on amino acid sequence. In that study, an expression classifier was created—the algorithm that allowed predicting protein expression based on amino acid sequence parameters known to have effect on expression from experimental data set. Therefore, the step 60 of screening different proteins for the optimal expression can be accomplished by the step 100 of in silico screening large protein set for the optimal expression in the desired host that yields much smaller set of the proteins with increased probability of successful expression. The smaller set of proteins is then screened in vivo for the best expression. To our knowledge the approach described in the step 100 is not currently applied for screening of large sets of in silico generated protein mutants.

According to a preferred embodiment of the invention, certain a.a. sequence parameters can be used to predict expression of native proteins (step 100) and then combined in a process at step 200 to create a novel computational protein optimization method that combines computational a.a. sequence parameters optimization with gene codon optimization (step 90) and yields in silico gene mutants with predicted improved expression.

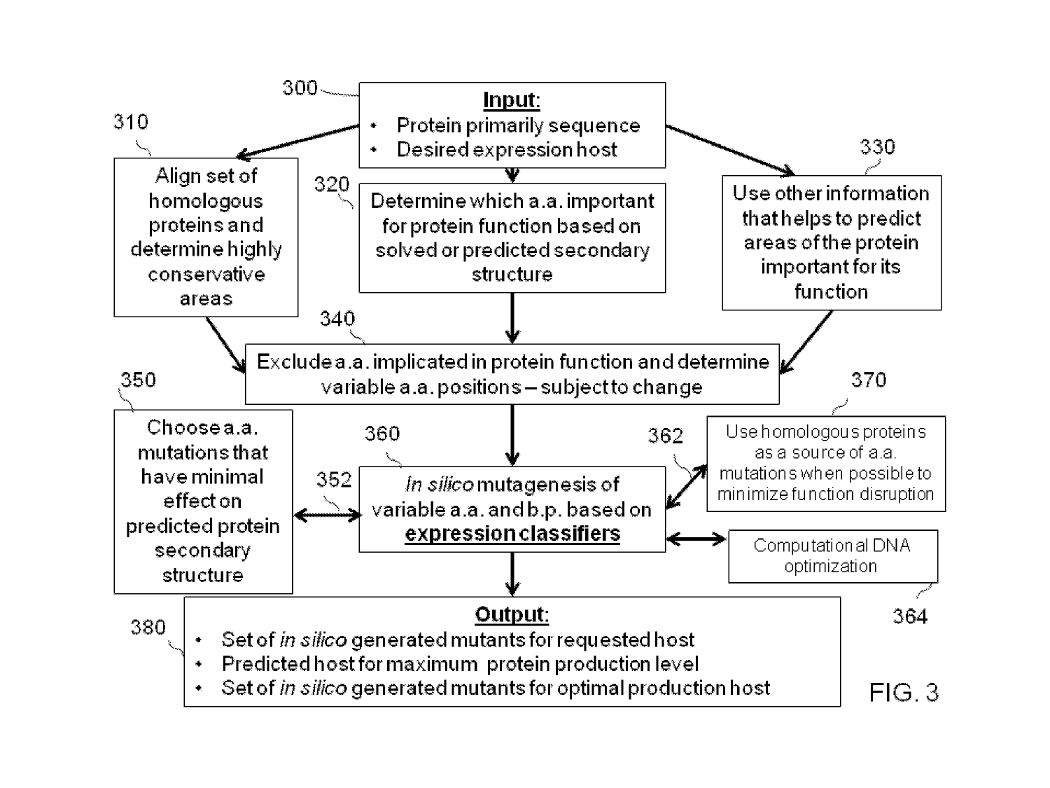

The major steps of a novel protein production optimization process by in silico mutagenesis according to a preferred embodiment of the invention are shown in FIG. 3. At step 300, input information is collected. The input information can include the amino acid sequence of a protein of interest and a desired expression host.

According to one preferred embodiment, in the first step the software will predict the amino acids important for protein of interest function and structure. In the step 310 protein databases are used to access sequences of proteins homologous to the protein of interest. Those protein sequences are then aligned and the conservative amino acid positions are determined as a result of step 310. In parallel, at step 320 databases of solved protein structures can be accessed and the structure of the protein of interest or its close homolog can be found. If no solved structure is available, then the protein structure can be predicted computationally. Step 320 yields amino acids positions important for protein function and structure, which function and structure are predicted based on solved or calculated secondary structure(s) and information about active sites of proteins having function and structure similar to the protein of interest. Step 330, which is parallel to the steps 310 and 320, is an optional step and comprises gaining any other information that could be helpful for prediction of which amino acids are important for protein structure and function. One example of such optional information is literature about research on side-directed mutagenesis of protein active site(s). The optional information found is then analyzed manually and additional amino acids that are important for function are determined as a result of step 330. In the step 340, all available information on functionally important residues is collected from steps 310, 320 and optional step 330. Those amino acids are deducted from the list of amino acids that will be subject to possible change. Step 340 then yields the list of variable amino acids positions that will be a subject to change in consequent steps.

According to at least one preferred embodiment, still referring to FIG. 3, in the second major step two algorithms can be used in parallel to optimize both DNA and protein sequence (step 360 in FIG. 3). These algorithms can be termed “expression classifiers”. Each classifier is expression-host-specific and must be created in advance based on one or more data sets for expression of multiple proteins for protein optimization (See Van den Berg et al., 2010, incorporated herein by reference in its entirety) or the same protein with multiple codon optimization variants for DNA optimization (See Welch et al., 2009; Gustafsson et al., 2012, both of which references are incorporated herein in their entirety). The goal of the protein sequence classifier is to introduce a minimal amount of mutations and to create a set of sequences that have the highest score based on classifier parameters. When possible, the mutations can be taken from infologs—the proteins homologous to the protein of interest, in order to decrease the risk of disrupting protein function (See Govindarajan, 2012, incorporated by reference herein in its entirety). Step 370 consists of search for the possible amino acid substitutes based on infologs information. In the interactive 362 process, information from step 370 is incorporated into step 360 of computational mutagenesis. In parallel, the secondary structure of mutants can be calculated and generated in the step 350 and these calculations can be used to remove from the set of potential mutants those that would have an effect on predicted protein secondary structure. The information about amino acid substitutes that have minimal effect on protein secondary structure is incorporated into step 360 in the interactive 352 process.

In at least one embodiment there are 19 possible substitutions of natural amino acids (a.a.) available for each variable position (VP). The number of amino acid substitutions (#a.a.) times the number of variable positions (#VP) raised to the power of (#VP-1) provides the total number of mutant variations that the software routine can generate, of which one will correspond to the subject protein. Thus the total number of mutants, TM, is given by the expression

TM=[(#a.a.)#VP̂(#VP-1)]−1

To illustrate with a trivial example, if each candidate protein were to have only three variable positions, vp1, vp2 and vp3, then a full set of mutant candidates would be TM=(20*3̂2)−1, or TM=119 mutant candidates. In many instances, there may be hundreds to thousands of variable positions, so that the total number of mutant candidates to be run through the classifier can be quite large.

In alternative embodiments, however, in order to reduce the computational load, for one or more of the variable positions, VP(i) for i=1, 2, . . . n, there can be offered fewer possible substitutions in the mutation creation step for one or more of the variable positions. In such an instance, some of the 20 naturally occurring amino acids are removed from the substitution list based on a pre-filtering step applied for one or more variable positions. In such a pre-filtering step, one or more possible amino acids may be eliminated for a variable position, VP(i), based on an assessment of infologs, for example, where the evaluation of infologs can identify a “safe” set of substitution amino acids for that variable position that are less likely to negatively impact function and/or activity.

Also, in one or more alternative preferred embodiments, the number of variable positions can be reduced using certain decision rules. One rule can be to limit variable positions to only those related to the surface of the secondary structure, based on the rationale that these are more likely to affect solubility. To accomplish this, off-the-shelf (OTS) software can be used that predicts secondary structure for any particular variable position and then those positions that are not close to the surface can be removed from the mutation creation step.

It should be noted, also, that one or more embodiments of the invention can utilize synthetic amino acids that are in addition to or in place of the twenty naturally-occurring amino acids.

In one or more embodiments, the classifier will be host-specific, protein-location specific (such as, for example, cell-associated versus secreted, intra-cellular location, membrane location, etc.) and specific with respect to homologous versus heterologous proteins. An example of one such classifier that has been used to predict expression/secretion level is a specific Asperiligis niger/homologous/secreted.

Alternatively, in at least one embodiment of the invention, steps 370 and 350 can be optional steps and in the absence of these steps an exhaustive set of mutants can be generated by a software routine that steps through every variable position, beginning at VP(n) for n number of variable positions, and then loops through all substitutions for that position (which can be all 20 amino acids in some cases), and then stepping back to VP(n−1) and making a substitution at VP(n−1) and then again looping through all possible substitutions for variable position VP(n), then making another substitution at VP (n−1) and so forth until a full set of mutants is created (numbering one less than #a.a. X #VP̂(VP-1)).

The parameters used to build protein sequence classifier(s) can be protein sequence parameters such as amino acid composition, GC content, RNA secondary structure, amount of charged amino acids on the surface, length of the protein, nucleotide composition, hydrophobic peaks, hydrophilic peaks, isoelectric points, among other parameters.

Referring again to FIG. 3, according to at least one preferred embodiment of the invention, after a single optimal mutant (or a set of in silico mutants) has been determined from running the in silico mutation subroutine at step 360, which may have been optionally informed by step 350 (with respect to secondary structure effects) and step 370 (with respect to infologs and/or other homolog analysis), then an additional optimization step based on another classifier subroutine can be applied, which additional step in at least one embodiment can be a computational DNA optimization step 364. This is a codon-optimization step that can further provide classification scores to the DNA sequence coding the protein(s) optimized at step 360.

The parameters used to build DNA sequence classifier for step 364 can be parameters such as sequence repeats, splice sites, RNA secondary structures, poly A sites, killer motifs, codon usage, GC content, codons read by tRNAs that are most highly charged during amino acid starvation, and other parameters. As a result of multiple DNA and protein parameters optimization, the set of in silico mutants is generated at any desired amount in the step 380. In one or more preferred embodiments, those mutants optimized in silico can then be screened for expression in a chosen host to determine the best performing mutant in vivo.

Furthermore, in situations where there is flexibility with respect to one or more possible expression hosts that can be used, then the protein of interest sequence can be run through classifiers for multiple hosts. The optimal choice of expression host can be found and a set of mutants can be generated for this optimal host. In this case, the step 380 that consists of output information collection will include also predicted host for maximum protein production level and set of mutants for this host.

The method described on the FIG. 3 can be included into bioinformatics services. The service based on described above method will include software that analyzes customer gene sequence in the context of one or several expression hosts and generates set of gene mutants with sequences optimized for expression in customer host. The software will also generate list of optimal hosts for the customer protein and generate sets of gene mutants with sequences optimized for expression in the recommended hosts. The software can be delivered to the customer as online service or for purchase on a disk.

Computer System

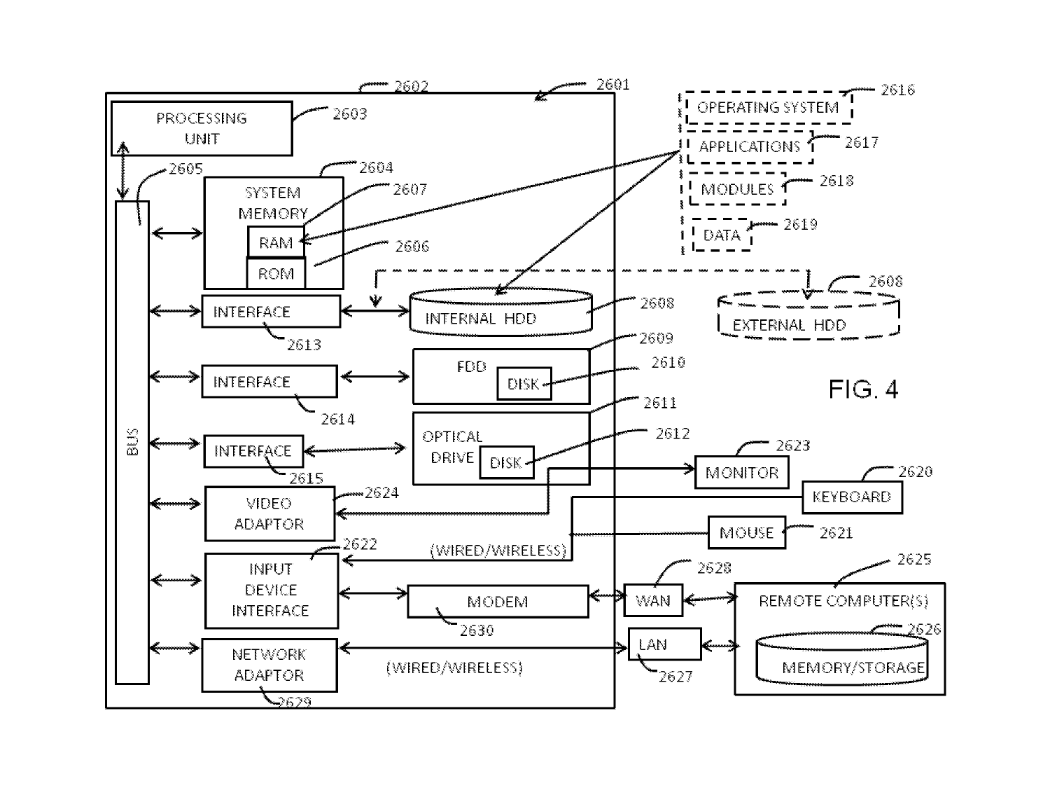

Referring now to FIG. 4, there is illustrated a block diagram of a computer operable to execute the disclosed architecture. In order to provide additional context for various aspects of the subject invention, FIG. 4 and the following discussion are intended to provide a brief, general description of a suitable computing environment 2601 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 4, there is illustrated an exemplary environment 2601 for implementing various aspects of the invention that includes a computer 2602, the computer 2602 including a processing unit 2603, a system memory 2604 and a system bus 2605. The system bus 2605 couples system components including, but not limited to, the system memory 2604 to the processing unit 2603. The processing unit 2603 can be any of various commercially available processors. Dual microprocessors and other multi-processor architectures may also be employed as the processing unit 2603.

The system bus 2605 can be any of several types of bus structure that may further interconnect to a memory bus (with or without a memory controller), a peripheral bus, and a local bus using any of a variety of commercially available bus architectures. The system memory 2604 includes read only memory (ROM) 2606 and random access memory (RAM) 2607. A basic input/output system (BIOS) is stored in a non-volatile memory 2606 such as ROM, EPROM, EEPROM, which BIOS contains the basic routines that help to transfer information between elements within the computer 2602, such as during start-up. The RAM 2607 can also include a high-speed RAM such as static RAM for caching data.

The computer 2602 further includes an internal hard disk drive (HDD) 2608 (e.g., EIDE, SATA), which internal hard disk drive 2608 may also be configured for external use in a suitable chassis (not shown), a magnetic floppy disk drive (FDD) 2609, (e.g., to read from or write to a removable diskette 2610) and an optical disk drive 2611, (e.g., reading a CD-ROM disk 2612 or, to read from or write to other high capacity optical media such as the DVD). The hard disk drive 2608, magnetic disk drive 2609 and optical disk drive 2611 can be connected to the system bus 2605 by a hard disk drive interface 2613, a magnetic disk drive interface 2614 and an optical drive interface 2615, respectively. The interface 2613 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 2602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 2607, including an operating system 2616, one or more application programs 2617, other program modules 2618 and program data 2619. All or portions of the operating system, applications, modules, and/or data can also be cached in the RAM 2607. It is appreciated that the invention can be implemented with various commercially available operating systems or combinations of operating systems.

A user can enter commands and information into the computer 2602 through one or more wired/wireless input devices, e.g., a keyboard 2620 and a pointing device, such as a mouse 2621. Other input devices (not shown) may include a microphone, an IR remote control, a joystick, a game pad, a stylus pen, touch screen, or the like. These and other input devices are often connected to the processing unit 2603 through an input device interface 2622 that is coupled to the system bus 2605, but can be connected by other interfaces, such as a parallel port, an IEEE 1394 serial port, a game port, a USB port, an IR interface, etc.

A monitor 2623 or other type of display device is also connected to the system bus 2605 via an interface, such as a video adapter 2624. In addition to the monitor 2623, a computer typically includes other peripheral output devices (not shown), such as speakers, printers, etc.

The computer 2602 may operate in a networked environment using logical connections via wired and/or wireless communications to one or more remote computers, such as a remote computer(s) 2625. The remote computer(s) 2625 can be a workstation, a server computer, a router, a personal computer, portable computer, microprocessor-based entertainment appliance, a peer device or other common network node, and typically includes many or all of the elements described relative to the computer 2602, although, for purposes of brevity, only a memory storage device 2626 is illustrated. The logical connections depicted include wired/wireless connectivity to a local area network (LAN) 2627 and/or larger networks, e.g., a wide area network (WAN) 2628. Such LAN and WAN networking environments are commonplace in offices, and companies, and facilitate enterprise-wide computer networks, such as intranets, all of which may connect to a global communication network, e.g., the Internet.

When used in a LAN networking environment, the computer 2602 is connected to the local network 2627 through a wired and/or wireless communication network interface or adapter 2629. The adaptor 2629 may facilitate wired or wireless communication to the LAN 2627, which may also include a wireless access point disposed thereon for communicating with the wireless adaptor 2629.

When used in a WAN networking environment, the computer 2602 can include a modem 2630, or is connected to a communications server on the WAN 2628, or has other means for establishing communications over the WAN 2628, such as by way of the Internet. The modem 2630, which can be internal or external and a wired or wireless device, is connected to the system bus 2605 via the serial port interface 2622. In a networked environment, program modules depicted relative to the computer 2602, or portions thereof, can be stored in the remote memory/storage device 2626. It will be appreciated that the network connections shown are exemplary and other means of establishing a communications link between the computers can be used.

The computer 2602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with experimental results that contain both bands (dual band), so the networks can provide real-world performance similar to the basic 10BaseT wired Ethernet networks used in many offices

### Functional Specification for the Software Modules

According to one preferred embodiment of the invention, generally, the protein expression optimization method and system can be deployed on a stand-alone computer in the form of computer software, wherein the optimization parameters and/or classification parameters can be graphically depicted in two, three or more parameter dimensions on the computer screen. A further embodiment provides generally for the protein expression optimization system to be enabled on a computer server and the computer program to be made available over a computer network, such as an intranet, or such as an internet, such as the World Wide Web, including a business method therefor.

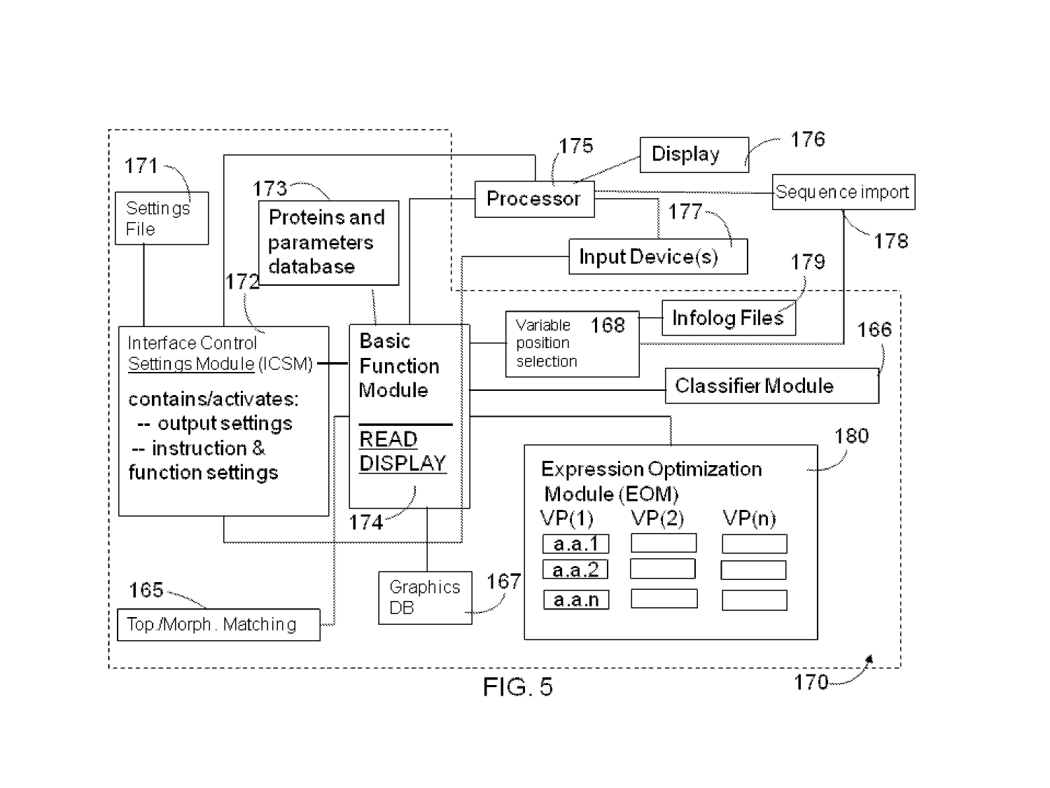

Referring to FIG. 5, an embodiment provides a protein expression optimization computer program 170, showing program components and connectivity for a protein expression optimization program. In one embodiment, a user can initiate the program 170 by controlling input device 177, such as, for instance, clicking on an executable program icon on a computer screen, or by initiating a Java program or other application programming element on a web page (via a web browser), which can activate interface control sub-program 172 and basic function sub-program 174, which can lead to display of program menu screens, which can be customized and stored in settings file 171. If the user chooses to activate the optimization functions, then the program can read the amino acid sequence list from the protein and parameters database 173 and can import these as amino acid sequences via the sequence import module 178, infolog files 179 and one or more input modules 177, and/or can display these via display 176. Further, the program 170 can, via module 180, create at least a subset of potential amino acid substitutions constructed from a subset of permissible natural amino acids and permissible synthetic amino acids wherein each set of possible substitutions, according to some embodiments of the invention, can be pre-selected for certain variable positions to create a minimal impact on function and activity through any arbitrary combination with any of the other associated substitutions for each of the variable positions (the protein a.a. sequences, infolog sequences and function-activity data and parameters coming from the database 173, which database 173 can in certain embodiments be a representation of a series of sub-databases, distributed databases and/or Internet cloud-based data.

Referring still to FIG. 5, an embodiment provides a computer, including a computer processor 175, readable and writable computer memory, and software program 170, which software program 170 controllably interacts with processor 175 (including one or more output devices, such as, without limitation, display 176 and/or other video output devices (such as a computer monitor, computer display panel, personal digital assistant display panel, digital telephone display panel, electronic book display, and/or electronic tablet display), and/or audio speaker or speakers 168, and/or other computer output devices known in the art, optionally at least one input devices 177 (including, without limitation, input devices such as a computer keyboard, computer mouse, electronic pen or scribe, trackball, touchpad, scanner, scanner with character recognition, microphone, and other known input devices).

Protein amino acid sequences stored in a protein and parameters database file 173 can be controllably displayed on display 176 and/or operated upon through variable position selector module 168. The computer can comprise one or more electronic computing devices, such as, without limitation, a server, a personal desktop computer, laptop computer, notebook computer, networked computing device, client/server configured computer. Optionally, a printer can be included as an output device.

Still referring to FIG. 5 and program 170, a subprogram or subroutine interface control setting module 172 can enable a user to change settings (such as, without limitation, output settings for display 176 or variable position selector 168, which settings can include control of routines to derive conservative regions for the subject protein and other aspects of selecting the subject protein sequences and desired variable positions. For example, without limitation, settings can be changed to alter the variable position selector 168 (such as, for example, choosing conservative regions, or use of secondary structure(s), or application of optional other information related to function/activity), and/or to change the number of variable positions, and/or the display can be changed from displaying amino acid sequences on the screen to displaying protein structures that can be rotated in three dimensions, and/or to change a display background to show other parameter dimensions and/or to segment the visual display into multiple windows, and/or to change the speed of operation of the program (including, without limitation, the speed of the program response and/or the time that the program can wait for human response to aspects of program interactivity. Settings can be stored in permanent or semi-permanent computer memory in a settings file 171, which can be stored on a computer disk in the operating computer, or on a portable disk (such as a CD, DVD, flash memory stick, or the like). In further embodiments, a settings file 171 can be stored on a network server on a local intranet and/or on the internet. The interface module 172 can allow individual users to have access to an individual settings file 171 unique to that user, which access can be secured by identification and/or authentification steps known in the art, which may include a userID and/or password. For example, a research monitor or supervisor could control the settings of the program for researchers accessing the computer in a user session (such as, without limitation, in a laboratory or over the internet), or a researcher could control his or her own settings (in a laboratory network, or on a personal computer in an office, and/or over the internet). In a further embodiment, a protein production business manager can be enabled to control settings for one or more accounts for customer researchers and/or protein-purchasing customers accessing the program via the Internet.

A basic functions subprogram 174 can be part of program 170 (FIG. 5), in which case basic functions program 174 can enable and control the program steps of reading an amino acid sequence and/or variable positions from the proteins and parameters database 173 and displaying the sequences and/or variable positions on the display 176. Basic function sub-program 174 can also include subroutines for selecting expression hosts, either directly or indirectly (via other subroutines), data inputs from settings files 171, other data files, other input files and/or other data from a variety of input devices 177. The classifiers and/or optimal mutant set can be displayed in numerous ways, including, without limitation, as output graphics.

The function/activity description and/or data for proteins and infologs, for example, can be also stored in the proteins and parameters database 173 and/or some aspects thereof stored in a separate visualization database 167, which visualization database can include protein structure objects and/or data related to computer graphics capability, virtual reality modeling language (VRML) objects and/or data related to 3-dimensional computer rendering capability (such as, without limitation, XGL, or other graphics standards known in the art).

An expression optimization module (EOM) 180, can be included in program 170 for assisting the user to observe how substitutions are associated with variable positions. HEM 180 draws from the proteins and parameters database 173 through the import and decision-rule functions of basic functions sub-program 174, ICSM 172 and processor 175.

Program 170 can be implemented in alternative software languages and configurations. For instance, it can be written in Visual Basic, C, C+, C++, C#, Perl, Java, LISP, Access and/or many other computer languages well known in the art, and/or in combinations thereof. For example, database files may be stored in Access or other commercial database structures and means known to persons skilled in the art of computer programming and/or writing software. It is to be understood that reference to software subprogram, subroutine, module, component or other program element can include implementation of program function as software objects, including all attendant and known methods of object-oriented software programming. Further, any description of software objects for a single computer are intended to include in the scope of the invention all similar software objects, such as Java, active server pages, applets, and other programming objects and/or methods for implementing the program capabilities in a web browser and/or within a client/server architecture running on a computer network, such as, for example, the Internet.

Embodiments of the invention provide for commercially available hardware, chips and/or software submodules to be combined with the basic software control code of program 170. For example, an off-the-shelf (OTS) classification software product, GeneLinker Platinum® (Integrated Outcomes Software, Kingston, Ontario) can be utilized for the classifier module 166, and/or additional filtering, constraint and/or classification modules can be written utilizing known methods.

A further embodiment provides for a reduced instruction set computer microcontroller (such as a peripheral interface controller—PIC) processor in order to provide easier communication with the host processor 175, an RS232 serial interface, I2C bus interface, and a parallel interface. The parallel interface can used for selecting one of a plurality of predefined sequence/structure/function/activity relationships. Alternatively, the program can search for parameters contained in the database 173 and/or in an additional parameter databases. The program can match topological and morphological aspects of structure, i.e., where variable positions can be checked for surface location in module 165.

Sequence matching can be incorporated in program 170 as a subroutine or as another program object matching function in module 165. Matching function 165 can take output from one or more input devices and/or from the classifier module 166 and match the input to one or more of the databases, such as protein and parameters database 173, which database can include sequence and structural data related to function/activity. The matching can be programmed as taking a user input, parsing and/or converting that input to an input string and testing for equivalence against a “match-test string” that is read by a sequential stepping and reading through the database records. Such matching routines can be similar to those used for sequence-matching in protein sequencing and/or homology routines, which are well-known to persons skilled in the art of writing bioinformatics software.

It will be appreciated and understood that the writing of the software program code for each subroutine or software object, as well as the connecting of the software components or objects for database control, for reading from databases, for displaying program output, for initiating classifier runs, and generating codon-optimized output, for programming system response to user input, for sequence-matching and/or for constructing function-safe sequences (from rules for structure/function/activity relationship) in module 180 is within the skills of and can be accomplished by a software programmer skilled in known and existing programming methods.

Also, it will be appreciated and understood that embodiments can provide for alternative software program configurations closely related to program 170, such as, for example, programs having only a subset of the components depicted in program 170, and/or programs having additional subprograms and/or subroutines known in the art.

### Data Analysis Engine and Classifier Generation Module

A data analysis engine can include specific unique and custom algorithms and/or data analysis routines and/or it can provide an interface (by ‘wrapping’ and/or interconnecting to) to multiple off-the-shelf (OTS) commercial software packages that are well known to those skilled in the art of data analysis, such as, for example without limitation, Rosetta®, GeneSpring®, SAS®, Excel®, Spotfire®, GeneLinker® (Integrated Outcomes Software, Kingston, Ontario) and other packages). GeneLinker®, for example, is an OTS software that can create classifiers from training datasets.

Additional functionality can be programmed into the data analysis engine according to one embodiment, including evolutionary algorithms, fitness functions, multiple objective functions and constraint functions, cellular automata and neural network systems, by one having ordinary skill in the art and utilizing further guidance from “Bio-Inspired Artificial Intelligence: Theories, Methods and Technologies,” Dario Floreano and Claudio Mattiussi, (2008), MIT Press, Cambridge Mass. 659 pp., incorporate herein in its entirety by reference hereby.

Optimization of any step in the protein expression optimization modules, including for example, optimizing fit of parameters and/or classifiers with user-specified goals and change in the expression host, can be programmed using any methods outlined by M. Athans and P. L Falb in “Optimal Control: An Introduction to the Theory and Applications, Dover Publications, Mineola, N.Y., (2007), 877 pp., which is hereby incorporated herein by reference in its entirety.

The data analysis engine can include, through distributed access, any number of analytical functions that can operate on data, wherein a preferred embodiment of the invention can include at least filtering, regression and correlation, a more preferred embodiment can additionally include one or more of recursion analysis, hash tables, binary search trees and B-trees, and a most preferred embodiment can additionally include methods for sub-linear association mining (SLAM), integrated Bayesian Inference (IBIS), self-organizing maps (SOMs), and reverse-engineering, among other algorithms, wherein these module can be programmed accordingly by one having ordinary skill in the art and using such techniques, methods and approaches as are provided in Brian D. O. Anderson, “Optimal Filtering,” Dover Publications (2005), Mineola, N.Y., 357 pp.; in “Mathematical Techniques for Biology and Medicine, William Simon, (1987), Dover Publications, New York, N.Y., 295 pp.; in “Introduction to Algorithms, 2′ Edition, Thomas H. Cormen et al., MIT Press, Cambridge, Mass., (2001); “Statistical Digital Signal Processing and Modeling”, Monson H. Hayes, John Wiley & Sons (1996), 608 pp.; and in “Pattern Classification, 2′ Edition”, Richard O. Duda, Peter E. Hart and David G. Stork, (2001), J. Wiley and Sons; all of teachings are hereby incorporated herein by reference in their entirety.

### Classifier

A classifier is a function that maps an input attribute vector, x=(x.sub.1, x.sub.2, x.sub.3, x.sub.4, x.sub.n), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVMs are configured via a learning or training phase within a classifier constructor and feature selection module. Thus, the classifier(s) can be used to automatically learn and perform automatically a number of functions.

In one implementation, an AI component can be disposed on the network in communication with a first experimental device and/or protein optimization module, and/or additional devices and/or modules, and even the process and process equipment, where desired, including without limitation high throughput screening (HTP) equipment, such that the type of modules uploaded to a given experimental or screening device can change in accordance with either predetermined criteria or learned criteria.

In another implementation, the AI component can determine which modules operate together in a more optimized manner. For example, it can be determined that the experimental and/or screening processes control module and data acquisition module may or may not operate optimally with certain expression hosts. When detected, the AI component can facilitate selecting modules from the library and swapping modules to optimize operation of the device according to a given process task and/or according to a specific expression host.

In yet another application, the AI component can be utilized to determine the best combination of expression optimization module and expression-host selection module, and/or screening device and research equipment.

It will be appreciated that the protein expression optimization system described herein in certain embodiments, including pseudo-code illustrating the methods and system of embodiments of the invention, can be implemented by one skilled in the art of software programming in one or more different programming languages, or combinations of programming languages, including, for example, such languages and programming tools and approaches as object-oriented programming (or OOP, including, without limitation, software objects, software classes, databases, loops, relational operators, pointers, inheritance, polymorphism), C# (including C# version 3.0), JavaScript, Python, C++, C, Perl, Visual Basic, PHP, Asynchronous Javascript and XML (AJAX), the .NET Framework 3.5, ASP.NET 3.5 and ASP.NET AJAX, Database/SQL/LINQ, XML/LINQ, WCF Web Services, OOD/UML, XAML, Visual Studio 2008, SQL Server Express, Transaction-Structured Query Language (T-SQL), HTML, XHTML, DOM API, XSLT and XPATH, CSS, XML, SVG, HTTP, SQL, XForms, WS-* Services and SOAP, CORBA, DAML+OIL, RDF, OWL, Web 2.0, WSDL, WS-* Services and WSDL, JSON, Java Servlets, secure socket layers (SSL), Mashups, RSS, Atom Syndication Format (ASF), AtomPub, web-based ontologies, and further using, among other known and described programming methods and approaches, the programming methods, routines, techniques and technologies known to practitioners and described in the following treatises, which are each incorporated herein in their entirety: “Ajax Bible.” Steve Holzner. Wiley Publishing, Inc., 2007, Indianapolis, Ind. 695 pp.; “C#2008 for Programmers. Third Edition (Deitel Developer Series). Paul J. Deitel and Harvey M. Deitel. Prentice Hall, New York N.Y., 2008. 1251 pp.; “Programming Python.” Mark Lutz, O'Reilly Media, Inc., Sepastapol, Calif. 2006. 1552 pp.; “Pro T-SQL 2008 Programmer's Guide,” Michael Coles, Apress, Berkely Calif. (2008), 659 pp.; “Professional Web 2.0 Programming,” Eric van der Vlist, Danny Ayers, Erik Bruchez, Joe Fawcett, Alessandro Vernet, 2007, Wiley Publishing, Indianapolis, Ind. 522 pp.; “Beginning C#3.0: An introduction to Object-Oriented Programming,” Jack Purdum, 2007, (Wrox) Wiley Publishing, Inc., Indianapolis, Ind. 523 pp.

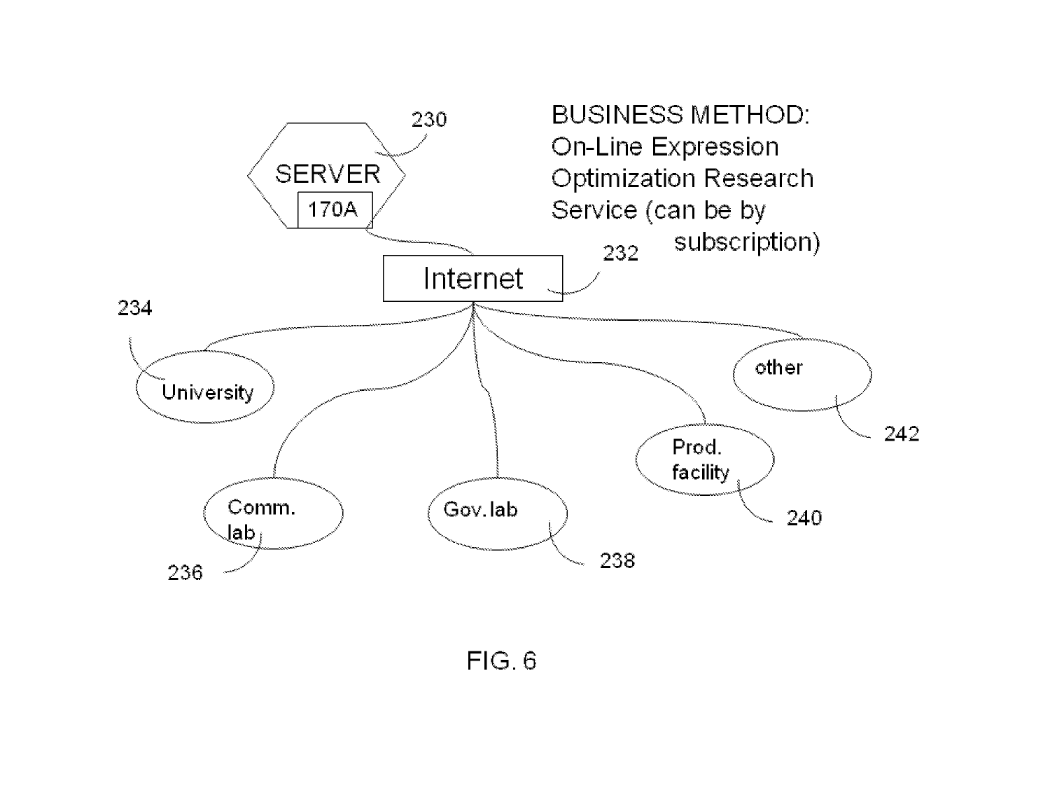

Referring to FIG. 6, an on-line learning system can be combined with a business method according to an embodiment of the invention whereby the expression optimization program 170A is made active and available from a provider/server through a computer network 232, such as, for example, the Internet and/or World Wide Web, to a plurality of clients 234-242, including university 234, commercial laboratory 236, government offices 238, production facilities 240 and other clients 242, locally within one state or geographic region, nationally within one country, such as, for example, within the United States, and/or internationally.

Referring again to FIG. 3, also, in one or more alternative preferred embodiments, the number of substitute amino acids can be reduced using certain decision rules in an optional manual step. Some particular amino acids can be preferred, discriminated against or excluded. For instance, charged amino acids can be preferred as substitutes at the variable positions located at the surface of the protein. As another example, substitute amino acids that create new N-glycosylation sites can be excluded. If there is some other information that indicates that particular substitute amino acids could have positive or negative effect on protein function or expression, this information also can affect the choice for substitute amino acids.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The following publications (references) relate to aspects of the invention and contain various procedures useful in combination for enabling at least one preferred embodiment of the invention, appropriately accessible to one of ordinary skill in the relevant art, and each and every publication is incorporated by reference herein in its entirety.

### REFERENCES

1. Van den Berg B A, Nijkamp J F, Reinders M J T, Wu L, Pel H J, Roubos J A, and De Ridder D. Sequence-Based Prediction of Protein Secretion Success in Aspergillus niger. T. M. H. Dijkstra et al. (Eds.): PRIB 2010, LNBI 6282, pp. 3-14, 2010. Springer-Verlag Berlin Heidelberg 2010
2. Siegel J B, Zanghellini A, Lovick H M, Kiss G, Lambert A R, St Clair J L, Gallaher J L, Hilvert D, Gelb M H, Stoddard B L, Houk K N, Michael F E, Baker D. Computational design of an enzyme catalyst for a stereoselective bimolecular Diels-Alder reaction. Science. 2010 Jul. 16; 329(5989):309-13.
3. Lutz S. Beyond directed evolution-semi-rational protein engineering and design. Curr Opin Biotechnol. 2010 December; 21 (6):734-43.
4. Gustafsson C, Minshull J, Govindarajan S, Ness J, Villalobos A, Welch M. Engineering genes for predictable protein expression. Protein Expression and Purification 83 (2012) 37-46.
5. Welch M, Govindarajan S, Ness J E, Villalobos A, Gurney A, Minshull L, Gustafsson C. Design parameters to control synthetic gene expression in Escherichia coli. PLoS One. 2009 Sep. 14; 4(9):e7002.
6. Govindarajan S. Using infologs as information-rich gene variants to engineer enzymatic function. ECI Enzyme Engineering XXI Conference. Sep. 18-22, 2011
7. Maté D, García-Burgos C, García-Ruiz E, Ballesteros A O, Camarero S, Alcalde M. Laboratory evolution of high-redox potential laccases. Chem. Biol. 2010 Sep. 24; 17(9):1030-41.
8. Wong D W, Batt S B, Lee C C, Robertson G H. High-activity barley alpha-amylase by directed evolution. Protein J. 2004 October; 23(7):453-60.
9. Wilson. E S, Kautzer C R, Antelman D E. Increased protein expression through improved ribosome-binding sites obtained by library mutagenesis. Biotechniques. 1994 November; 17(5):944-53.

What is claimed is:

1. A method for improving protein production, comprising the step of generating mutants in silico with DNA and protein sequence optimized for expression.

2. The method of claim 1, wherein the protein sequence optimization is based at least one of a protein and DNA sequence parameter that has effect on protein expression or secretion.

3. The method of claim 2, wherein the protein sequence optimization is based on a sequence parameter selected from the group of amino acid composition, GC content, RNA secondary structure, amount of charged amino acids on the surface, amount of aromatic amino acids, length of the protein, nucleotide composition, hydrophobic peaks, hydrophilic peaks, and isoelectric points.

4. The method of claim 3, wherein the protein sequence optimization is based on an amino acid composition sequence parameter and amino acid sequence positions selected to be changed (variable positions) are predicted to have minimal effect on protein function and activity based on (i) solved or predicted secondary structure, (ii) alignment with homologous proteins and (iii) other evidence.

5. The method of claim 4, wherein variable positions are changed to amino acids (substitute amino acids) that have minimal effect on protein function and activity based on a sequence of homologous proteins (infologs), based on predicted secondary structure of mutants and based on other evidence.

6. The method of claim 5, wherein the DNA sequence of the protein encoding gene is optimized for better expression by optimizing parameters from the group of sequence repeats, splice sites, RNA secondary structures, poly A sites, killer motifs, codon usage, and GC content.

7. The method of claim 6, wherein the protein expression is homologous or heterologous.

8. The method of claim 7, wherein the protein expression is cell-associated or extracellular (secretion).

9. The method of claim 8, wherein the expression host is one of bacteria, yeast, filamentous fungi, mammalian cells, insect cells, plant, algae, protest and any organism that can be used for protein production.

10. A business method implemented over the Internet and by computer, comprising the steps of
providing online to customers a protein expression optimization service that generates mutants in silico with DNA and protein sequence optimized for expression, wherein the protein sequence optimization is based at least one of a protein and DNA sequence parameter that has effect on protein expression or secretion, wherein further the protein sequence optimization is based on a sequence parameter selected from the group of amino acid composition, GC content, RNA secondary structure, amount of charged amino acids on the surface, amount of aromatic amino acids, length of the protein, nucleotide composition, hydrophobic peaks, hydrophilic peaks, and isoelectric points; wherein further the protein sequence optimization is based on an amino acid composition sequence parameter and amino acid sequence positions that have been selected to be changed (variable positions) and that are predicted to have minimal effect on protein function and activity based on (i) solved or predicted secondary structure, (ii) alignment with homologous proteins and (iii) other evidence; wherein further, variable positions are changed to amino acids (substitute amino acids) that have minimal effect on protein function and activity based on a sequence of homologous proteins (infologs), based on predicted secondary structure of mutants and based on other evidence; wherein the DNA sequence of the protein encoding gene is optimized for better expression by optimizing parameters from the group of sequence repeats, splice sites, RNA secondary structures, poly A sites, killer motifs, codon usage, and GC content; wherein the protein expression is homologous or heterologous; and wherein the protein expression is cell-associated or extracellular (secretion); and wherein the expression host is one of bacteria, yeast, filamentous fungi, mammalian cells, insect cells, plant, algae, protest and any organism that can be used for protein production; and
initiating a software module that analyzes a customer's gene sequence and generates a set of gene mutants with sequences that are optimized for expression in the customer's selected expression host, wherein the software module also generates a list of optimal hosts for the customer's protein and generates sets of gene mutants with sequences optimized for expression in recommended hosts.

11. A system for optimizing protein expression, implemented in computer software that is delivered to the customer as an online service or is purchased on an installable compact disk.
